(19) United States
(12) Patent Application Publication
(10) Pub. No.: US 2011/0215114 A1
(43) Pub. Date: Sep. 8, 2011

(54) DISPENSING PART FOR A WATER COOLER, AND WATER COOLER COMPRISING SUCH A PART

(75) Inventor: Robert Liccioni, Lesigny (FR)

(73) Assignee: TREFLE GROUPE, Evry (FR)

(21) Appl. No.: 13/128,067

(22) PCT Filed: Nov. 4, 2009
(86) PCT No.: PCT/FR2009/052129

§ 371 Date: May 6, 2011

(30) Foreign Application Priority Data
Nov. 7, 2008 (FR) 0857599

(51) Int. Cl. B67D 7/80

(52) U.S. Cl. 222/146.6; 222/185.1

(57) ABSTRACT

A dispensing part (1) for a bottled water cooler for dispensing water at least two different temperatures, using water drawn by gravity from an interchangeable water bottle, includes a finger (32) to be inserted into the neck of the water bottle (58) for drawing water, a water outlet pipe and an air inlet pipe for the water bottle to replace drawn water, elements for dispensing the water drawn by the drawing finger, communicating with the water outlet pipe, at the base of the withdrawal finger, and elements for supplying ambient air connected to the air inlet pipe (34), wherein the dispensing elements and the air supply elements are capable of enabling the formation of a water column from the water bottle, in the dispensing elements and above the level of the base of the drawing finger. A water cooler including such a dispensing part is also described.

The present invention concerns water coolers for dispensing water at different temperatures, namely chilled water, water at room temperature and/or hot water. The water is normally gravity fed from an interchangeable bottle that is placed upside-down on top of the water cooler. This kind of water cooler (see for example the document WO 02/062664) includes a dispensing lid that supports the bottle and is disposed above a fixed or removable open cooling tank, generally made from stainless steel or rigid plastic.

The cooling tank is fed via a drawing finger that is inserted in a watertight manner into the neck of the bottle and includes a water outlet pipe and an air inlet pipe. It is in contact with a heat exchanger, for example of the Peltier effect type, the compression type or the Stirling type, which cools the water contained in the cooling tank which constitutes a reserve of chilled water that may be dispensed via a chilled water tap and that is continuously renewed, each time water is drawn off.

Moreover, to ensure that water is drawn off correctly, the dispensing taps must be located substantially at the level of the bottom of the cooling tank; they are often fixed to the latter. This increases the overall height of the water cooler because some height must be provided under the taps to place the beaker or a filling container. To make possible to dispose the dispensing taps at a higher level, for example at the level of the dispensing lid, an air pump or a water pump could be provided, although this would increase significantly the cost price.

A general object of the present invention is arrangements making it possible to avoid this drawback and also conferring other advantages.

It has the particular object of providing a water cooler of the aforementioned type in which the cooling tank may be vented to the atmosphere and the dispensing taps may be disposed at a high level relative to the open cooling tank, in particular just above it, in order to reduce the overall height of the water cooler.

To be more precise, it provides a dispensing part for bottle water coolers for dispensing at two different temperatures at least water drawn by gravity from an interchangeable bottle, including a water drawing finger intended to be engaged in the neck of the bottle and that comprises a water outlet pipe and an air inlet pipe into the bottle to replace the water drawn off, means for dispensing water drawn off via the drawing finger, communicating with the water outlet pipe at the base of the drawing finger, and means for supplying ambient air connected to the air inlet pipe, characterized in that the dispensing means and the air supply means are adapted to allow the formation of a column of water coming from the bottle in the dispensing means and above the level of the base of the drawing finger.

This arrangement makes it possible to increase the height of the water level in the tank to have a good flow rate at the outlet from the dispensing taps. Moreover, the cooling tank is vented to the atmosphere and the distance between the water inlet orifice of the cooling tank and the dispensing taps is reduced, which makes it possible to reduce the overall height of the water cooler.

Moreover, if a water heater associated with the cooling tank is used, the expansion of the water in the water heater that occurs on heating causes the water to rise, which is not a problem, whilst leaving the water heater open to the atmosphere.

According to particular features, possibly combined:

the air supply means include an air inlet situated approximately at the level of an inlet in the drawing finger for water coming from the bottle;

the dispensing part includes means for shutting off an air supply passage into which discharges the air inlet of the supply means, the shut-off means being adapted to be actuated to close the passage by the column of water if the level thereof accidentally exceeds a predetermined level;

the air supply means include a swan-neck-shape pipe the free end of which forms the air inlet;

the water dispensing means include a chimney in which stands the swan-neck-shape pipe and which discharges at its base into a compartment for dispensing water at different temperatures;

the dispensing part includes a water passage orifice intended to communicate with a cooling tank, a water at room temperature drawing outlet, a pipe for feeding chilled water from the cooling tank to a chilled water drawing outlet that the dispensing part also includes;

the dispensing part includes a water at room temperature outlet intended for a water-heater and a drawing outlet for water heated by the water-heater;

the dispensing part is made in two parts, namely an upper part including the chimney and a lower part taking the form of a deflector for dispensing water at different temperatures, adapted to be attached to the upper part;

the dispensing part takes the form of a lid adapted to cover in sealed manner a cooling tank of the water cooler that is open at the top;

an air filter is accommodated in the upper opening of the chimney and the shut-off means include a valve for shutting off the opening controlled by a float adapted to be actuated by the water column, mounted in the chimney under the air filter;

the dispensing part has a flared overall shape, the air supply means including a swan-neck-shape pipe running laterally alongside the dispensing part and the free end of which forms the air inlet;

the ambient air supply means include a calibrated orifice for evacuating water when placing the bottle;

the drawing finger includes a chicane adapted to oppose entry of water into the air inlet pipe during placing of the bottle.

The invention also provides a water cooler including a dispensing part as defined above.

According to particular features relating to the water cooler, possibly combined:

the water cooler includes a cooling tank in two parts, disposed under the dispensing part, the upper part of this tank forming with the dispensing part a compartment for dispensing water at different temperatures, the tank being equipped with outlets for water at different temperatures in this upper part;

the air supply passage is formed in the upper part of the cooling tank and the shut-off means include a float provided with a member for shutting off the passage pivotally mounted in the upper part of the cooling tank;

the water cooler includes a removable second tank that is nested in the cooling tank;

the removable tank includes a channel that is formed in the exterior face of its wall and that constitutes an air passage between the exterior of its wall and the interior of the wall of the cooling tank;

the removable tank is produced in a plastic material that includes silver ions;

the water cooler includes a silver ion diffuser in the cooling tank or the removable tank;

the water cooler includes an air filter disposed on the air supply passage;

dispensing taps are fixed to the tank at the level of the tank water inlet;

the dispensing taps are mounted by means of quick-fit connectors on outlet tubes that are attached to the tank;

the water cooler includes at least one additional pipe that is connected to a water at room temperature outlet tube and/or to a chilled water outlet tube;

the water cooler includes a deflector that is disposed in the tank and divides the tank into two parts;

the deflector includes a connector for a dip tube to pass through intended to draw chilled water from the bottom of the tank;

the water cooler includes a hot water tap that is adapted to be connected by a quick-fit connector to a double connector, preferably by coaxial pipes, which connector is intended to be connected to a water-heater by two pipes, one for water at room temperature, the other for hot water.

In an advantageous embodiment, the cooling tank is surmounted by a chimney for forming the column of water, the upper opening of which constitutes the air inlet of the bottle and in which is disposed a swan-neck-shaped pipe that is connected to the air inlet pipe of the drawing finger.

A float is advantageously disposed in the chimney so as to be able to shut off the upper opening of the chimney.

In a development of the invention that is novel in itself, a removable open second tank may be added to the fixed or removable tank of the water cooler, nested in the main cooling tank, generally of stainless steel or rigid plastic, and in thermal communication with the cooling tank. This makes it possible to dispense with cleaning the stainless steel or plastic first cooling tank by simply replacing the removable tank, which may be produced at low cost. In particular, it may be produced in a thin synthetic material that advantageously includes silver ions for eliminating microorganisms.

Thus, according to another aspect, a water cooler for dispensing water at two different temperatures at least from water at room temperature drawn by gravity from an interchangeable bottle intended to be placed upside-down on the water cooler or from a drinking water network by means of an adapter includes a cooling tank for the water at room temperature with a view to producing chilled water intended to be delivered via a chilled water drawing tap, the tank being open at the top and accommodated in cooling means, characterized in that a removable second tank is nested in the cooling tank.

According to particular provisions relating to this aspect, possibly combined:

the cooling means include an insulative enclosure in which is installed an exchanger evaporator exchanging heat with the exterior face of the wall of the cooling tank;

the removable tank is produced in a synthetic material;

the removable tank includes a channel provided on the exterior face of its wall, adapted to form an air passage between the exterior of the wall of the removable tank and the interior of the wall of the cooling tank;

the synthetic material includes silver ions;

the cooling tank is a fixed or removable tank;

the cooling tank is produced in stainless steel or rigid plastic material;

the plastic material is chosen in the group comprising polyethylene terephthalate (PET), polystyrene (PS), acrylonitrile-butadiene-styrene (ABS), and polyethylene (PE) of foodstuffs grade.

To be even more precise, the removable tank may include a channel that is provided on the exterior face of its wall and constitutes an air passage between the exterior of its wall and the interior of the wall of the main cooling tank.

This arrangement facilitates placing the removable tank in the cooling tank by allowing evacuation of air between the two tanks.

According to another advantageous feature of the invention, the water cooler may include a deflector that is disposed above the cooling tank and directs water coming from the bottle directly toward a water at room temperature outlet tap.

Thanks to this provision, the water at room temperature dispensing tap is fed directly by the bottle.

The deflector is advantageously disposed in the dispensing lid.

When there is provision for supplying hot water, the water cooler advantageously includes a supply pipe that is connected to the inlet of a water-heater and is fed via the deflector.

In another advantageous embodiment, a water cooler for dispensing water at different temperatures from water drawn by gravity from an inverted interchangeable bottle includes a receiving lid that supports the bottle and is disposed above a cooling tank that is supplied via a drawing finger that is inserted in sealed manner into the neck of the bottle and includes a water outlet pipe and an air inlet pipe that communicates with an air inlet passage of the bottle and communicates with the atmosphere.

It is in particular noteworthy in that the external air inlet passage of the water cooler is provided in the upper part of the tank, above the upper end of the water drawing finger, and communicates with the air inlet pipe via a pipe.

As indicated above, this makes it possible to place the dispensing taps at a higher level relative to the tank.

According to one particular feature of this embodiment, the aforementioned pipe is of swan-neck shape.

The pipe is advantageously provided in the receiving lid.

According to a further particular feature of this embodiment, the water cooler includes a float that is disposed in the tank and is pivotally mounted so as to shut off the air inlet passage that is provided in the lateral wall of the tank.

This makes it possible to provide a safety feature adapted to shut off the flow of water should the bottle be punctured.

The float is advantageously a hollow container of annular shape.

The water cooler more advantageously also includes a filter disposed on the air inlet passage.

According to a further advantageous feature of the invention, the dispensing taps are fixed to the tank at the level of the water inlet of the tank.

The dispensing taps are also advantageously mounted by means of quick-fit connectors on outlet tubes that are fastened to the tank.

This makes it possible to facilitate the fitting of the dispensing taps.

This also makes it possible to send chilled or water at room temperature to a carbonating device so as to be able to supply carbonated water.

According to a further advantageous feature of the latter embodiment, the water cooler includes a deflector that is disposed in the tank and directs water coming from the tank toward the water at room temperature tap and/or toward a water-heater.

The deflector preferably has the general shape of a horizontal disk.

This disk may include a central hole for direct passage of water from the bottle into the tank.

It may equally include a connector for a dip tube to pass through intended to draw chilled water at the bottom of the tank.

According to another development of the invention, the water cooler includes at least one additional pipe that is connected to a water at room temperature outlet tube or to a chilled water outlet tube.

Other features and advantages of the invention will emerge from the following description of embodiments of the invention given by way of illustration, is in no way limiting on the invention, and refers to the appended diagrammatic drawings, in which:

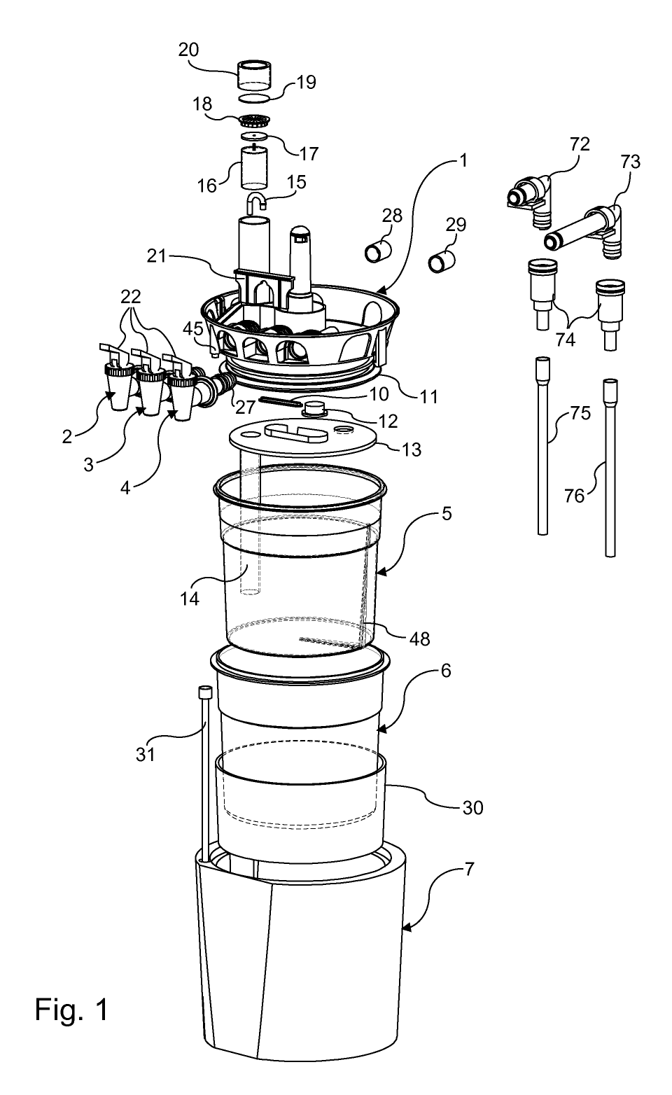

FIG. 1 is an exploded perspective view of an internal part of a water cooler of a first embodiment of the invention,

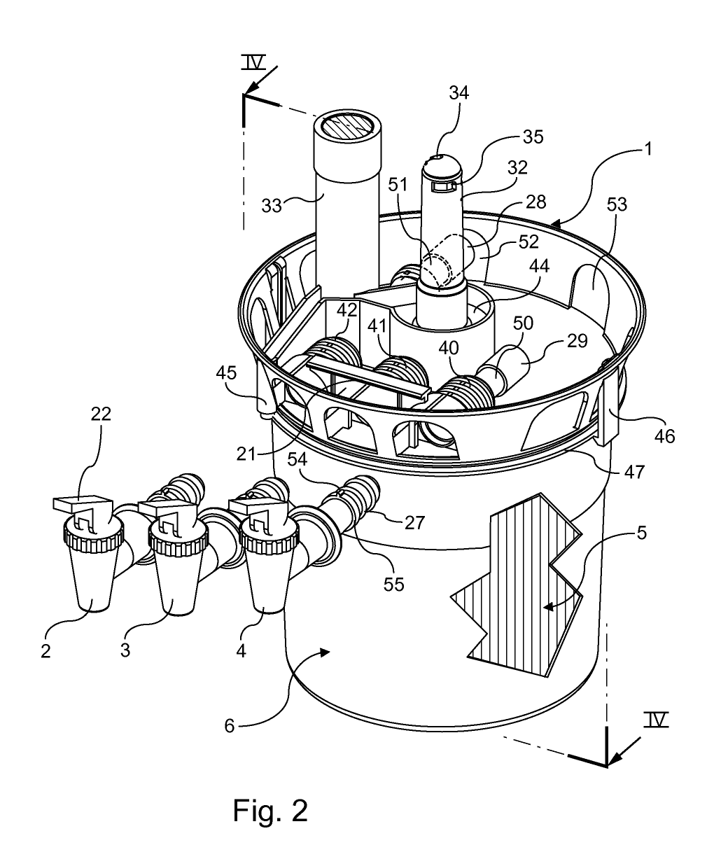

FIG. 2 is an exploded perspective view of part of a water cooler of this embodiment of the invention with the dispensing taps removed,

FIG. 3 is a perspective view from above of part of the water cooler, showing in particular the dispensing lid,

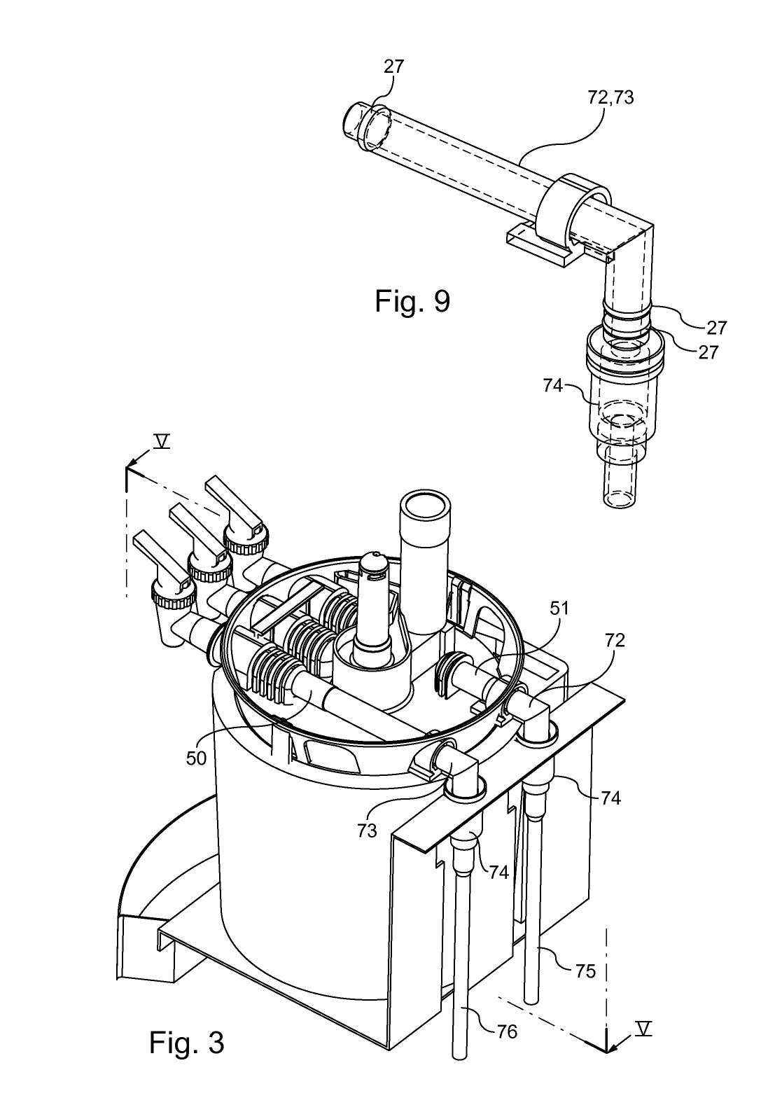

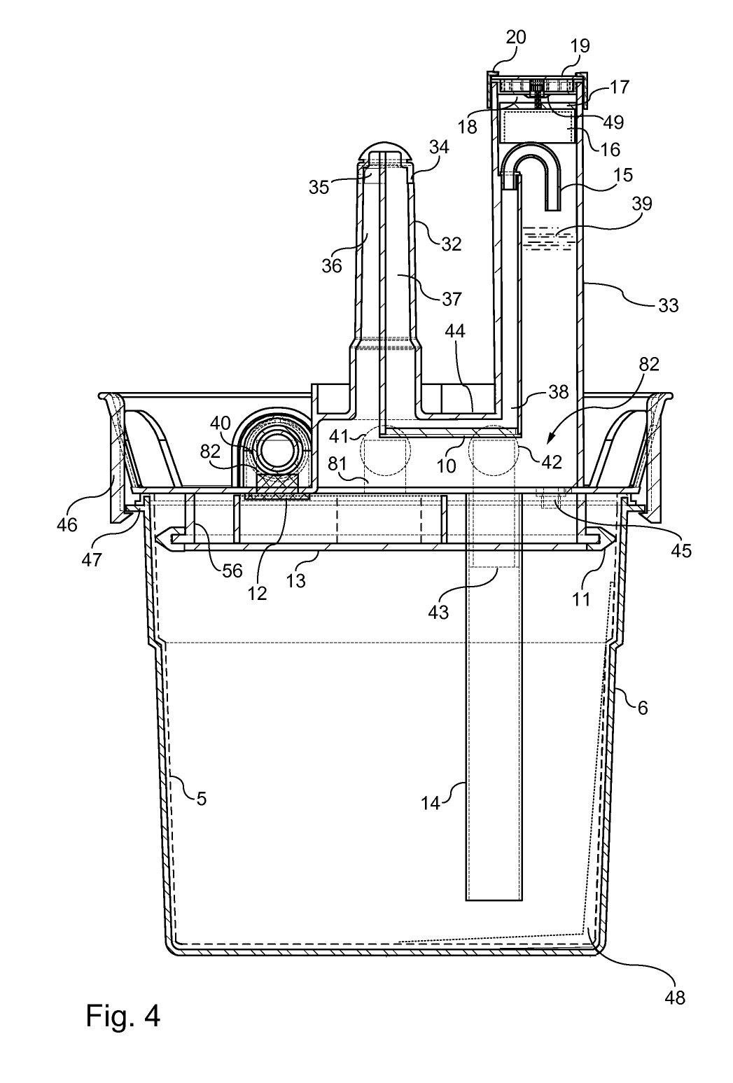

FIG. 4 is a view in section taken along the line IV-IV in FIG. 2,

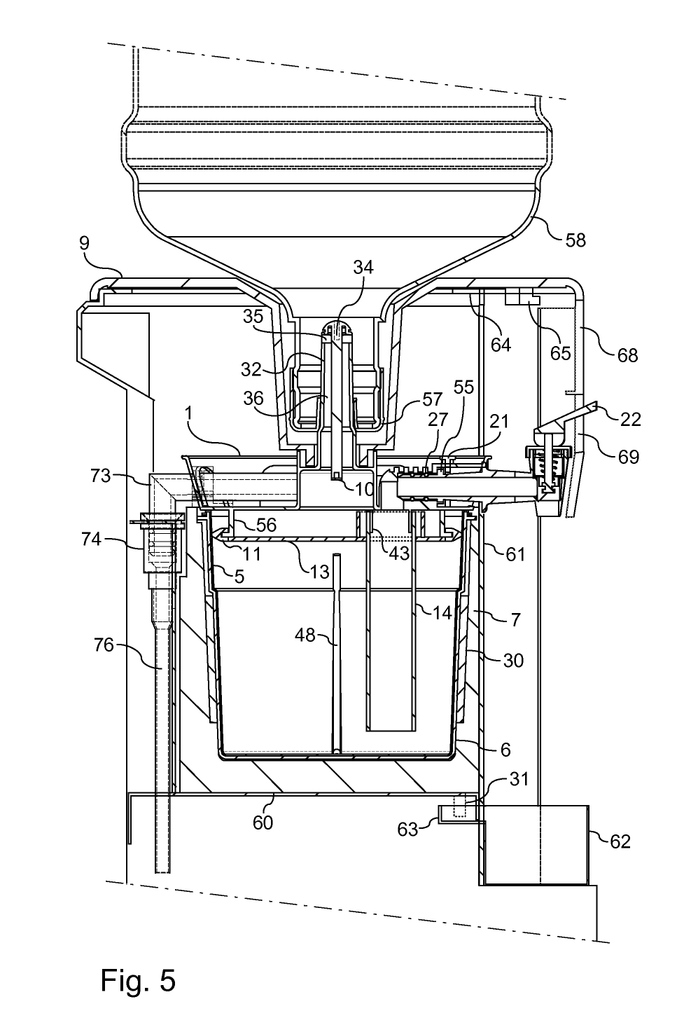

FIG. 5 is a view in section taken along the line V-V in FIG. 3, also showing an upper lid of the water cooler and part of a bottle,

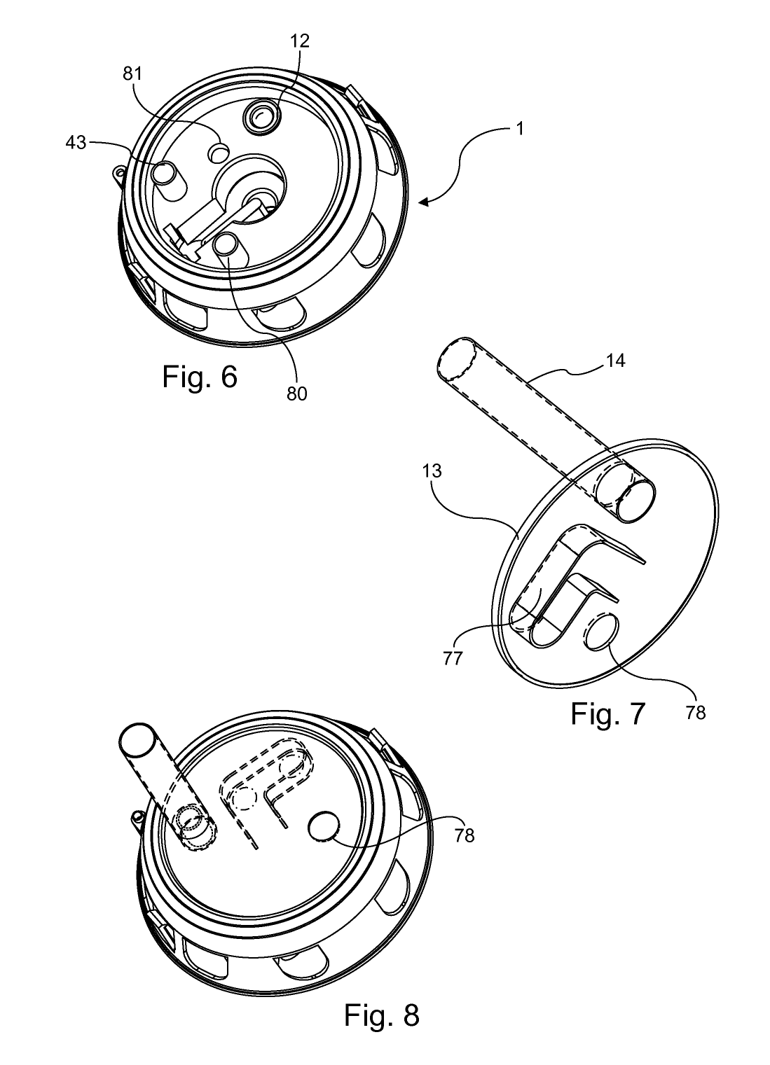

FIG. 6 is a perspective view of the bottom of the dispensing lid of the water cooler,

FIG. 7 is a perspective view of the deflector of the water cooler,

FIG. 8 is a perspective view of the dispensing lid and the deflector mounted under the dispensing lid,

FIG. 9 is a perspective view of a hot water or chilled water connector,

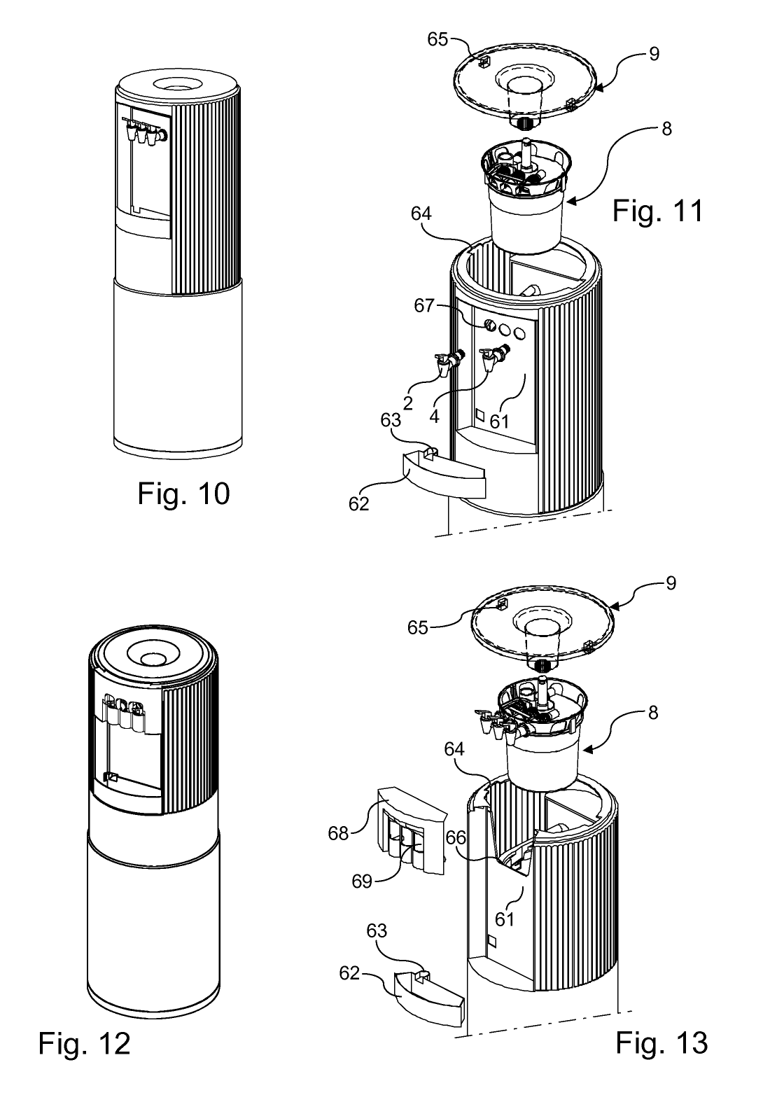

FIG. 10 is a general perspective view of the water cooler of the aforementioned embodiment, in which the dispensing taps are mounted on the front panel of the water cooler,

FIG. 11 is an exploded perspective view corresponding to FIG. 10,

FIG. 12 is a general perspective view of a different embodiment of this water cooler, including a cover concealing the dispensing taps,

FIG. 13 is an exploded perspective view corresponding to FIG. 12,

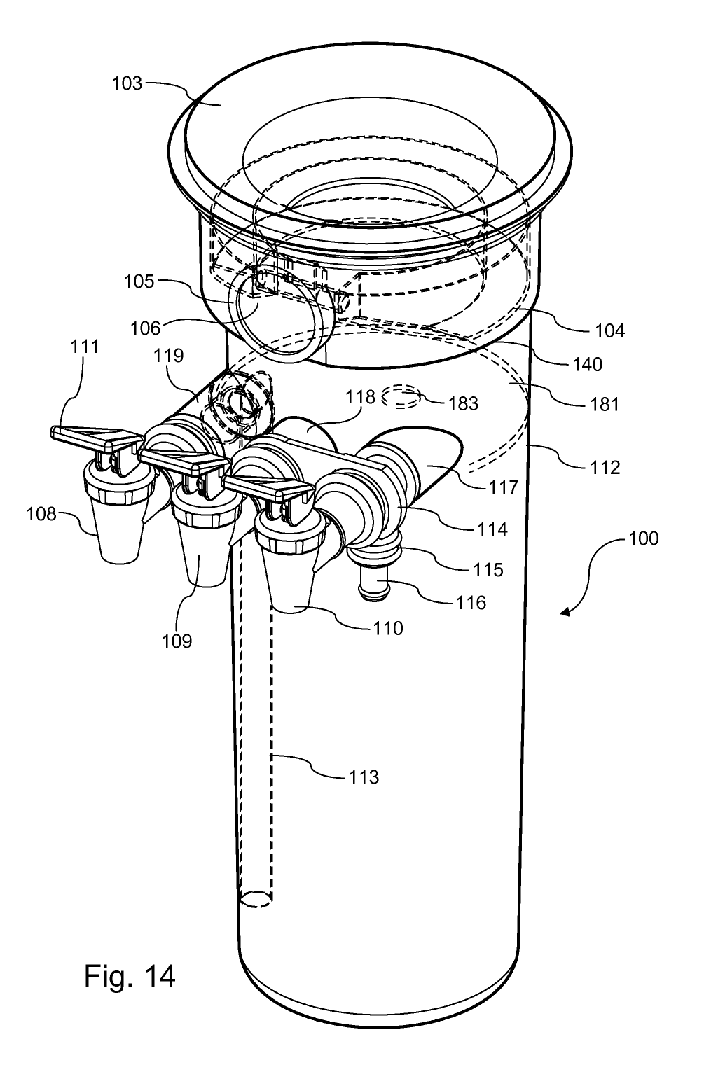

FIG. 14 is a perspective view of part of a water cooler of a second embodiment of the invention,

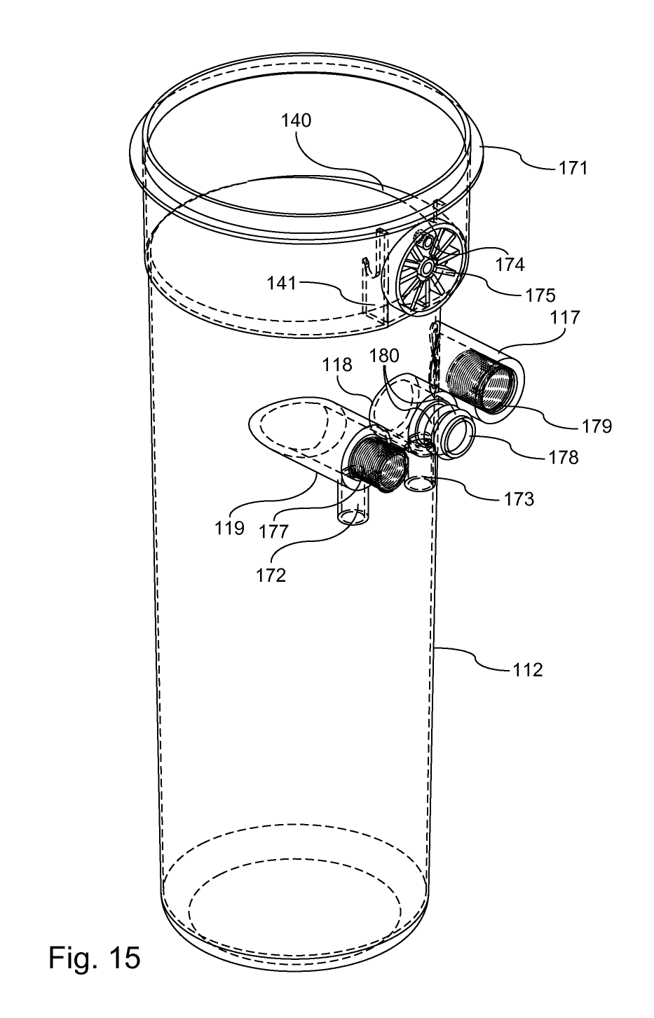

FIG. 15 is a perspective view of this part without a receiver lid and without dispensing taps,

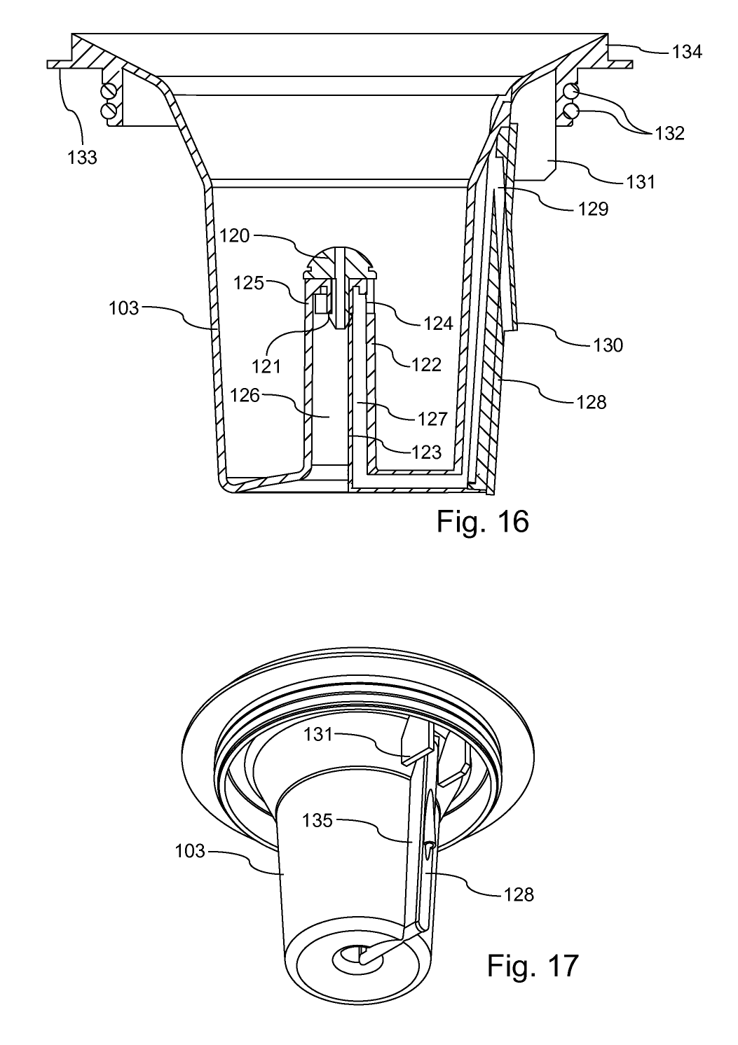

FIG. 16 is a view of the receiver lid in longitudinal section,

FIG. 17 is a perspective view of this receiver lid,

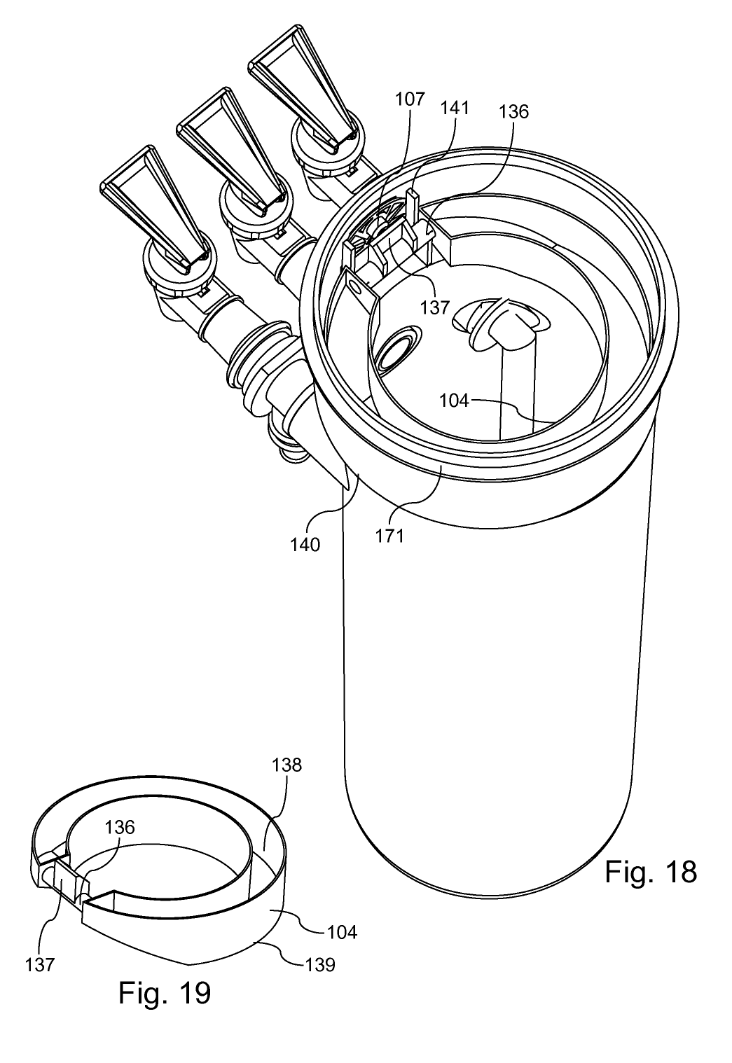

FIG. 18 is a perspective view from above of the tank of this water cooler part,

FIG. 19 is a perspective view from above of a float that is disposed in the tank,

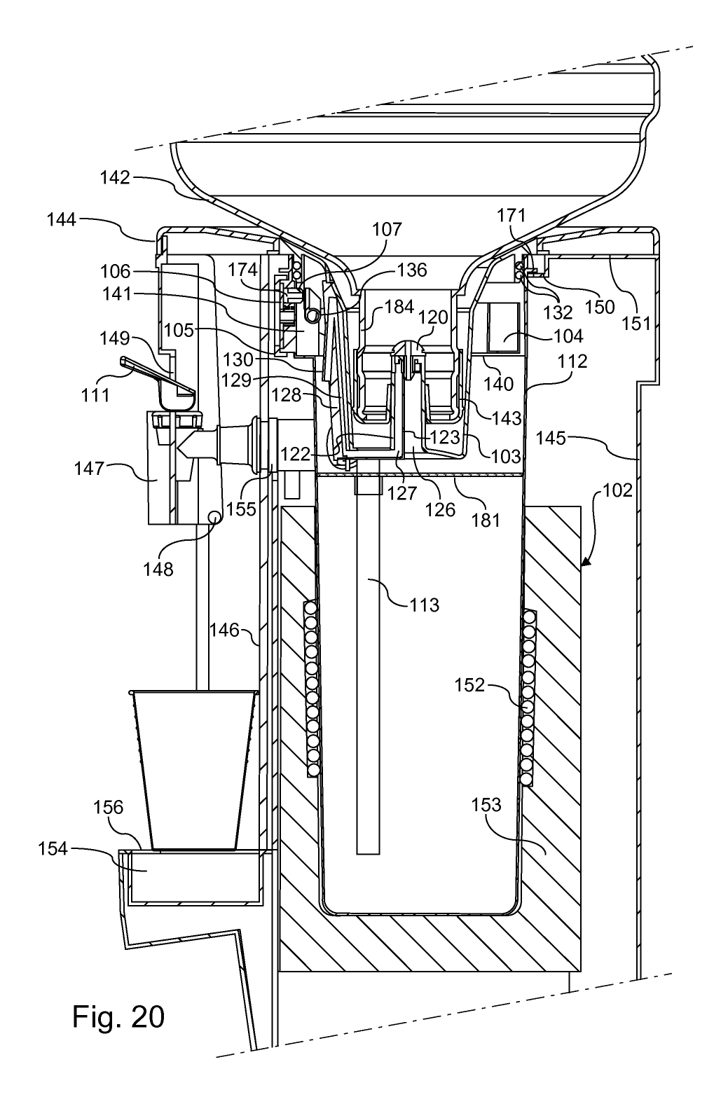

FIG. 20 is a partial view in longitudinal section of the water cooler with the lower part of a bottle disposed thereon,

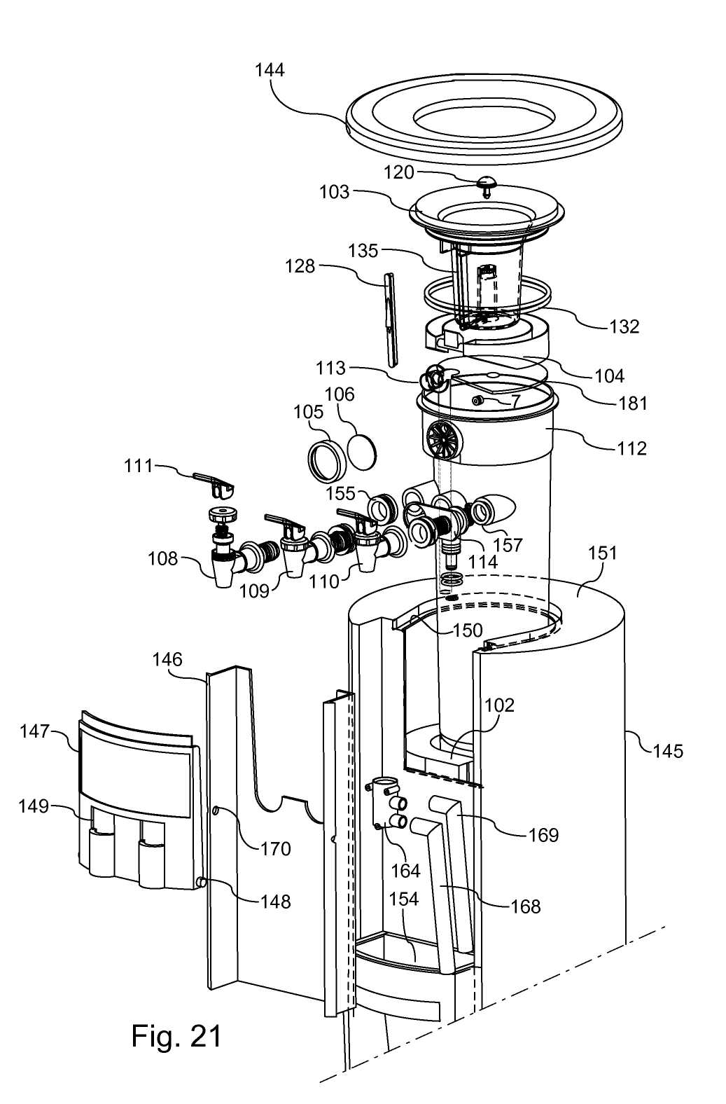

FIG. 21 is a partial exploded perspective view of the water cooler,

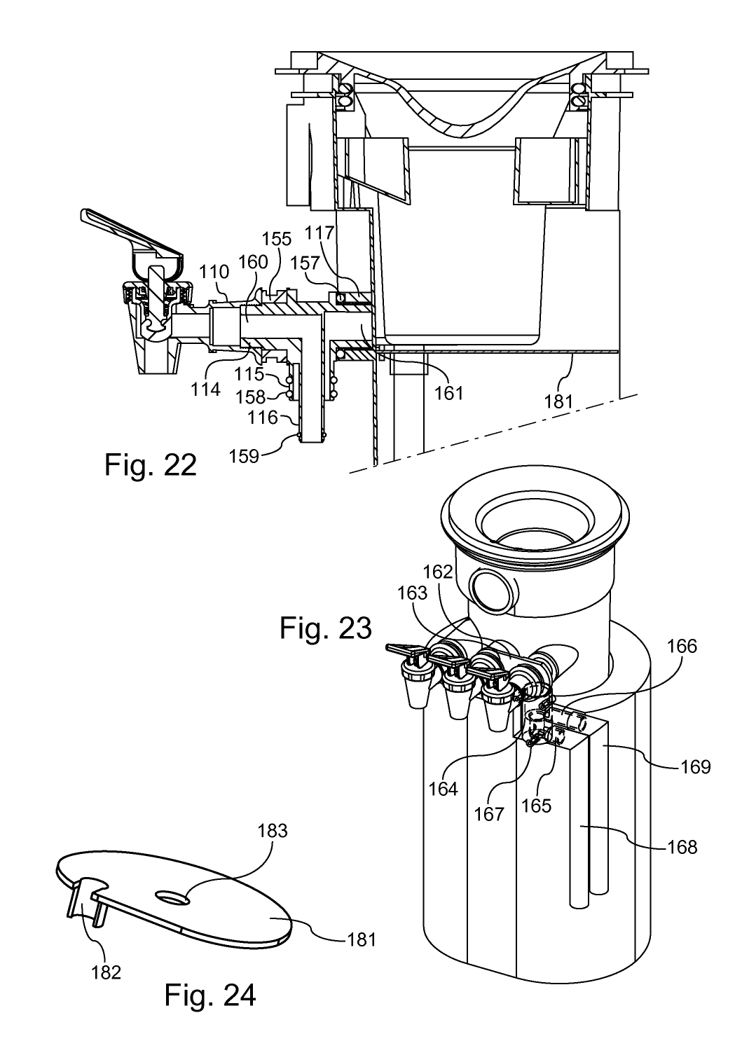

FIG. 22 is a partial view in longitudinal section of the upper part of the tank and the receiver lid,

FIG. 23 is a perspective view of the tank and its cooling jacket,

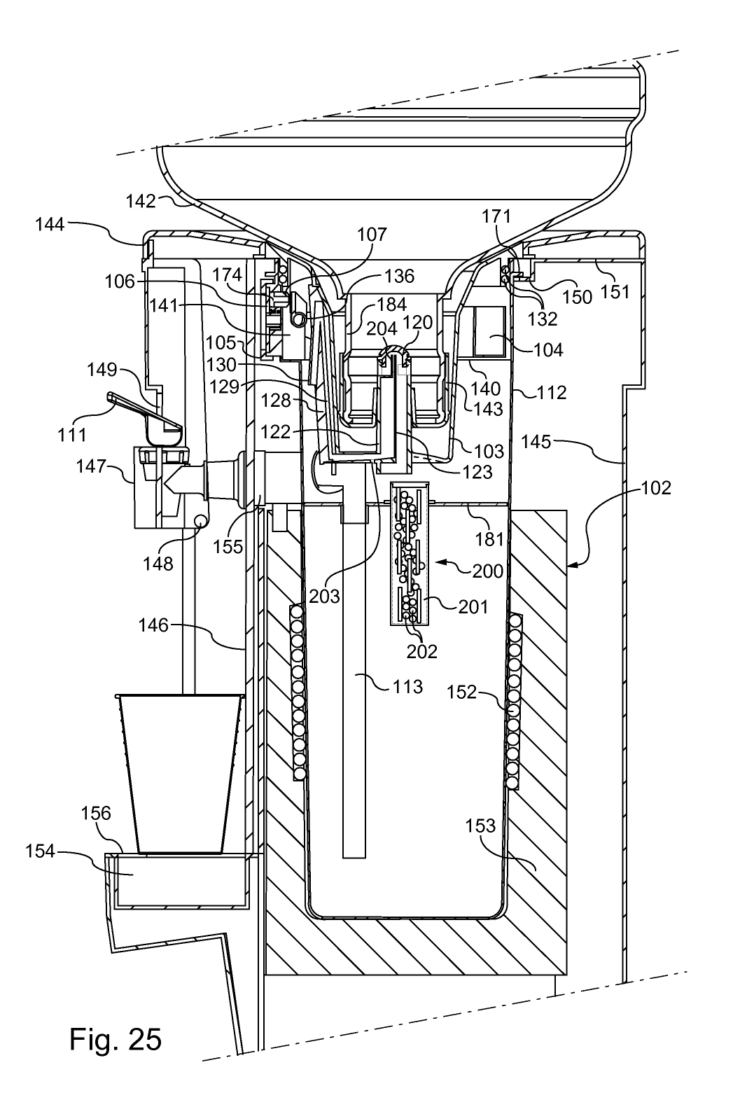

FIG. 24 is a perspective view of a deflector accommodated in the tank, and

FIG. 25 is a view similar to that of FIG. 20 and shows a different embodiment of the corresponding water cooler.

As shown in FIGS. 1 to 8, 12 and 13, the water cooler of a first embodiment of the invention includes a cooling tank 6 that is disposed in a cooling enclosure 7 and on which is disposed a dispensing lid 1 that is intended to receive an inverted bottle 58 (FIG. 5) that includes a stopper 57 at the end of its neck.

As described hereinafter, this dispensing lid distributes water at different temperatures to dispensing taps and external supplies and to this end includes a water dispensing compartment 82.

The dispensing lid 1 is mounted in a watertight manner on the cooling tank 6, which is open to the atmosphere, and provides the connection between a water drawing finger 32 in the bottle 58 and this tank 6. Three externally controlled dispensing taps 2, 3 and 4, a hot water inlet connection 50 and a water at room temperature outlet connection 51 are disposed on the dispensing lid 1.

The cooling tank 6 exchanges heat by means of an exchanger evaporator 30 with the walls of the fixed cooling enclosure 7 and rests on a support plate 60 able to support its weight.

The water drawing finger 32, here made in one piece with the dispensing lid 1, includes a passage for feeding water via a water outlet opening 35 and a water inlet pipe 36 into the cooling tank 6 and an air inlet pipe 34 that discharges into a pipe 37 (see FIG. 4 in particular) that is connected by a junction part 10 to a pipe 38 that rises in a chimney 33 open to the atmosphere. Here the end of the pipe 38 terminates in a swan-neck-shaped pipe 15 discharging downward.

The end of the pipe 38 terminates in a swan-neck-shaped pipe 15 discharging downward to return water to the tank when placing the bottle. It may equally serve to reduce the height of water.

The air inlet being higher than the water outlet of the drawing finger, the cooling tank 6 is filled so as to raise the water level 39 of the cooling tank 6 well above the outlets connected to the dispensing taps 2 to 4, in practice to a level slightly lower than the water inlet of the drawing finger, which ensures good drawing by the dispensing taps 2 to 4.

The cooling tank 6 being open to the atmosphere via the chimney 33, the upper opening of the latter is equipped with an upper filter support 20, an air filter 19, and a lower filter support 18 with an air passage 49 and serving as a valve seat.

If the bottle 58 were punctured, water could escape via the filter 19, draining the content of the bottle 58. To remedy this drawback, a float 16 that includes a seal 17 is mounted in the chimney 33. The float 16 rising with the water in the chimney 33, it closes the air passage 49 of the lower filter support 18 by pressing its seal 17 onto the seat consisting of the air passage 49.

Note that if the cooling tank 6 is combined with a water heater, as is the case here, the expansion of the water in the water heater when heated causes a certain volume of water to rise in a pipe connected to the outlet connection 51 for water at room temperature. This additional volume of water raises the water level in the chimney 33, which accepts this surplus water whilst leaving the water heater open to the atmosphere and preventing hot water rising into the bottle.

The water drawing finger 32 is surrounded at its base with a recovery tray 44 (see FIG. 4) to evacuate water from a leak that may be produced when placing or removing the bottle; this water flows via a pipe 45 and then a tube 31 that is mounted in the cooling enclosure 7, to drain into a cavity 63 of a residual water tray 62 (see FIG. 5), which may be emptied.

A seal 11 is mounted on a ring 56 of the dispensing lid 1 to make the seal with the cooling tank 6.

The dispensing lid 1 has two retaining clips 46 which, at assembly time, locate under a rim 47 of the cooling tank 6 to hold it in place.

Another feature of this embodiment of the invention is the ability to mount a removable second tank 5 nesting snugly in the cooling tank 6. This removable tank 5 may be produced in synthetic material and with thin walls. The seal 11 shutting off the cooling tank 6 accommodates this difference in diameter. This thin-walled removable tank 5 has a channel 48 formed in the exterior face of its wall that constitutes an air passage between the exterior of its wall and the interior of the wall of the cooling tank 6. This air passage extends the height of the removable tank 5 and its function is to facilitate evacuation of air from the cooling tank 6 when mounting the removable tank 5 in the cooling tank 6.

Providing a low-cost replaceable removable tank 5 makes it possible to eliminate cleaning the cooling tank 6.

This removable second tank 5 may equally be made from a plastic material that uses the properties of silver ions to eliminate microorganisms, of the type known under the trade name Agion®.

On the top of the dispensing lid 1 there is a chilled water outlet 42 where water is drawn off from the bottom of the cooling tank 6 via a chilled water outlet dip tube 14 that is mounted on an outlet connector 43. There is also an outlet 41 or 40 for water at room temperature, depending on the version, and a deflector 13 is placed under these outlets 40 and 41 to direct water entering the cooling tank 6 or 5.

A hot water outlet 40 may also be provided; in this case a stopper 12 (see FIG. 4) shuts off an interior pipe 82 of the outlet 40. An elbow connector 73 (see FIG. 9 in particular) passes through a passage 53 in the lid and is connected to the hot water inlet pipe 50 when the stopper 29 is removed from it. An identical second elbow connector 72 passes through a passage 52 in the lid to be connected to the outlet 51 for water at room temperature after removing the stopper 28 from that pipe (see FIGS. 2, 3 and 9 in particular). This outlet communicates with a pipe 80 for drawing off water at room temperature provided under the dispensing lid 1 (see FIG. 6).

In a variant, the outlet pipe 51 for water at room temperature may also serve to feed other devices.

A quick connection is advantageously obtained by mounting elbow connectors 72 and 73 (see FIG. 9) that make the connection with the connectors 51 and 50 and enable a sealed connection to female connectors 74 (see FIG. 9 in particular) when placing the tank in the cooled compartment. These female connectors 74 are connected to tubes 75 and 76 intended to be connected to a water heater (see FIG. 3 in particular).

In this embodiment of the present invention a deflector 13 makes it possible to draw water directly from the outlet of the bottle 58 to feed an outlet for water at room temperature, i.e. an outlet at the temperature of the bottle, and/or a hot water outlet.

The deflector 13 is represented in more detail in FIG. 7. It includes a circular plate that is placed between the dispensing lid 1 and the cooling tank 6 or the removable tank 5. The upper face of the deflector 13 includes a guide 77 that consists of a vertical wall that delimits a chamber the open end whereof is below the water outlet of the water drawing finger 32 and which therefore receives water directly from the bottle 58 and directs it toward the water outlets 40 and 41. A hole 78 in the plate of the deflector 13 constitutes the passage 78 for feeding water from the bottle 58 into the cooled water tank 6 or 5.

The chilled water outlet dip tube 14 is fixed to the lower face of the deflector 13: it is placed on the chilled water outlet connector 43.

The stopper 12 that shuts off the pipe 82, with a view to using hot water, may be seen in FIG. 3.

The water cooler that has just been described may be used to dispense water in different ways.

A first version dispenses chilled water and water at room temperature. A chilled water outlet 42 is then used with water drawn off from the bottom of the cooling tank 6 via the dip tube 14 that is mounted on the outlet connector 43.

An outlet 40 for water at room temperature may be provided with water drawn off at the lower level of the dispensing lid 1. In this case a stopper 12 shuts off the pipe 81 of the outlet 41 that is not used.

A second version supplies chilled water and hot water. For the chilled water outlet 42, water is drawn off from the bottom of the tank via the dip tube 14 that is mounted on the outlet connector 43.

The outlet 41 is not used and the stopper 12 shuts off the pipe 81 from the outlet 41.

For the hot water outlet 40, a second stopper 12 shuts off the pipe 82 from the outlet 40, an elbow connector 73 (see FIGS. 2 and 3 in particular) passes through the passage 53 of the lid and is connected to the hot water inlet connection 50 when the stopper 29 has been removed, and a second elbow connector 72 passes through a passage 52 of the lid to be connected to the outlet 51 for water at room temperature after the stopper 28 is removed from this pipe.

A third version of the water cooler supplies chilled water, water at room temperature and hot water.

For the chilled water outlet 42, water is drawn off from the bottom of the tank via the dip tube 14 mounted on the outlet connector 43.

For the outlet 41 for water at room temperature, water is drawn off at the lower level of the dispensing lid 1.

As indicated above, for the hot water outlet 40, a second stopper 12 shuts off the pipe 82 from the outlet 40, an elbow connector 73 passes through the passage 53 of the lid and is connected to the hot water inlet pipe 50 when the stopper 29 has been removed from it. A second elbow connector 72 passes through a passage 52 in the lid to be connected to the outlet 41 for water at room temperature after the stopper 28 has been removed from this pipe.

The outlets 40, 41 and 42 accept quick-fit taps, screw-in taps or any other type of tap.

Quick-fit taps are introduced into the outlet orifices 40, 41 and 42 and O-rings 27 are mounted on the spigots of the taps: they provide the watertight connection. A guide 54 ensures vertical positioning and a flange 55 (see FIGS. 2 and 5) allows retention of the tap by a locking part 21 placed in front of this flange 55, but any other equivalent assembly could be used.

This type of O-ring seal is also used on the elbow connectors 72 and 73 (see FIG. 9).

Different dismantling modes may be provided. In the embodiment of FIGS. 10 and 11, the dispensing taps 2 to are mounted on the front panel 61. FIG. 11 shows that, after turning the lid 9 of the water cooler so that the fixing lugs 65 of this lid no longer coincide with cut-outs 64 in the top of the water cooler, the lid 9 of the water cooler is removed, the screw-type or quick-fit taps 2, 3 and 4 that penetrate into the water cooler via the holes 67 in the front panel 61 are removed, and the assembly 8 consisting of the dispensing lid 1 and the tank 6 corresponding to the embodiment of FIGS. 1 to 8 can be removed from the water cooler.

FIGS. 12 and 13 show a water cooler with an opening 66 on the front panel 61; a cover 68 is placed in front of this opening 66, allowing the levers 22 of the dispensing taps 2 to 4 to pass through orifices 69 (see FIG. 5).

FIG. 13 shows that the dispensing lid 1 of the water cooler is removed in the same manner: the tap cover is removed and the assembly 8 consisting of the dispensing taps 2 to 4 and the lid 1 assembled with the tank 6 can be removed from the water cooler.

If the cooling tank 6 is fixed into the water cooler, the dispensing lid 1 with its deflector 13, with or without the taps depending on the version, can be removed after removing the lid 9 from the water cooler in the same way as before, possibly with the tank 5.

The foregoing description explains clearly how the invention could not be predicted by the person skilled in the art and how it enables the objectives set for it to be achieved. In particular, by virtue of providing a chimney, preferably with an interior pipe of swan-neck shape, the overall height of the water cooler may be reduced and enable the tank to be open to the atmosphere, and possibly a water heater. The air entry level of the swan-neck may be raised substantially to the level of the water outlet of the bottle via the drawing finger.

The advantages of the invention also include the fact that, thanks to the deflector, the luke warm and/or hot water outlets are fed at the level of the outlet of the bottle and not from the tank. Moreover, using a removable tank makes it possible to simplify cleaning operations.

The water cooler of a second embodiment shown in FIGS. 14 to 24 includes an exterior jacket or body 145 in which is disposed a tank assembly 100 that is fed by a bottle 142 to supply water at different temperatures via dispensing taps 108, 109 and 110 that respectively deliver chilled water, water at room temperature (at the temperature of the bottle 142) and hot or water at room temperature.

The bottle 142 (see FIG. 20) is upside-down, its neck resting on a receiver lid (dispensing part) taking the form of a body 103 having a flared overall shape that is itself placed on a cooling tank 112. The tank 112 is placed in a cooling enclosure 102 that includes an exchanger evaporator 152 around and in contact with the tank 112. The assembly formed of the exchanger evaporator 152 and the part of the tank 112 intended to produce chilled water is housed in an insulative enclosure 153.

The water cooler also includes a support plate 156 for a beaker intended to be placed under one of the dispensing taps; under this plate is a tray 154 for collecting spilled water. The dispensing taps 108 to 110 are disposed behind a cover 147 that is adapted to pivot about horizontal axles 48 accommodated in respective holes 70 in a notched front panel 146 of the body 145 and includes an opening 149 for the levers 111 of the dispensing taps 108 to 110 to pass through.

The dispensing taps 108 to 110 are arranged in the upper part of the tank 112 as may be seen in FIGS. 20 and 21 in particular. They are attached to the tank 112 and, thanks to the aforementioned provisions, may be extracted with the latter without removing the body 145 from the water cooler. This facilitates cleaning the water cooler. To this end the upper face 151 of the body 145 of the water cooler also has a circular hole for the tank 112 to pass through. Around this hole is a rim 150 that serves as a support for a rim 171 of the tank 112 (see FIG. 18 in particular).

According to the present invention, as may be seen in FIGS. 18 and 19 in particular, a float 104 is mounted in the tank 112 and rests on a ring 140 that constitutes a shoulder in the upper part of the tank 112. This float 104 shuts off the air entry passage extending toward the bottle 142 to replace the water drawn off. This float 104 takes the form of a hollow container 138 of annular general shape that is delimited by a wall 139 that forms a rim. The ring is not complete: it is notched and includes at this location a horizontal pivot 136 mounted on lugs 141 of the tank 112. The height of the float 104 also decreases progressively at each of its extremities situated on either side of the notched part. This horizontal axle 136 includes in its central part a shut-off lever 137 that has an exterior face intended to shut off an air entry passage 174 provided in the upper part of the tank 112 (below the taps) and which, when water rises in the tank 112 and causes the float 104 to pivot, comes to bear on a member 107 forming a flexible seat accommodated in the passage 174 and forming an air entry orifice. An air filter 106 is disposed in front of this orifice for mounting by means of a mounting ring 105 on a finned support structure 75. The float 104 being pivotally mounted, a high pressure force is obtained on the seat of the member 107 because of the length of the lever arm consisting of the floating part and as a result effective shutting off of the air entry orifice.

The circuit for conveying air from the outside into the bottle 142 also includes a pipe 129 of the dispensing part 103 that is connected by an air entry pipe 127 in the bottle 142 to an air entry 124 that is provided in a drawing finger 122 in which the air entry pipe 127 is formed and that is intended to be inserted into the neck of the bottle 142. This drawing finger 122 is also part of the receiver lid 103.

The pipe 129 has a part of swan-neck shape that has an entry 130 that communicates with the passage 174 for entry of air from the outside into the water cooler. It extends upward from the entry 130 and then downward again, and connected to the vertical pipe 127 by a horizontal connecting pipe. This pipe 129 is formed by a single part 135 of oblong shape in one piece with the part of the receiving lid 103 and a wall 128 fixed to this part 135.

According to the present invention, a deflector 181 is provided to direct water coming from the bottle 142 directly toward the tap 109 for water at room temperature and toward a water-heater (not shown), to prevent chilled water being fed into the water at room temperature and hot water circuits. This deflector 181 is disposed in the tank 112 below the float 104 and the air pipes 127 and 129. It has the general shape of a horizontal disc that includes a central hole 183 for water from the bottle 142 to pass into a cooling part of the tank 112 and a connector 182 for a dip tube 113 to pass through in order to draw chilled water from the bottom of the tank 112.

The dispensing caps 108 to 110 are fixed to the upper part of the tank 112, substantially at the level of its water inlet. To this end, pipes 117, 118 and 119 are provided that discharge into the tank 112 above the deflector 181 and are respectively connected to the hot water tap 110, the tap 109 for water at room temperature and the chilled water tap 108. The pipe 119 is connected to the dip tube 113 which draws chilled water from the bottom of the tank 112 under the deflector 181. The pipe 118 discharges into the tank 112 just above the deflector 181, i.e. into the water dispensing compartment formed by the tank 112, the deflector 181 and the receiving lid 103 forming a dispensing part. The pipe 117 also discharges into the tank 112 just above the deflector 181, but includes a double connector 114 that is connected to a double female connector 164 so that a pipe 115 for water at room temperature (see FIGS. 14 and 21 to 23 in particular) may be connected to a tube 169 for water at room temperature that directs water at room temperature coming from the compartment above the deflector 181 toward a water-heater (not shown) which has a hot water outlet 168 connected to the hot water inlet pipe 116 that directs hot water toward the tap 110.

As may be seen in more detail in FIG. 15, the taps 108 to 110 may be screwed onto an outlet tube 177 with a male thread attached to the tank 112 or into an outlet tube 179 with a female thread also attached to the tank 112. A quick-fit connection arrangement may equally be provided, as on the outlet tube 178 that is attached to the tank 112 and includes a spigot fitted with O-rings 180.

FIG. 15 also shows that additional pipes 172 and 173 may be provided that are connected at least to one of the outlet tubes, in this example to two such tubes, namely the chilled water outlet tube 19 and the outlet tube 118 for water at room temperature. These two additional pipes 172 and 173 are provided, for example, to feed a carbonating unit to provide carbonated water or other devices.

FIGS. 16, 17, 20 and 21 show the receiving lid 103 that is housed in the upper part of the tank 112 and receives the neck 184 of the bottle 142. To this end the receiving lid 103 includes a frustoconical hollow lower part including the swan-neck pipe 129 and a flared upper rim on which the bottle 142 rests.

Inside the frustoconical part is the drawing finger 122 that is intended to be inserted in watertight manner into the neck 184 of the bottle 142. This drawing finger 122 includes a water outlet 125 that directs water from the bottle 142 toward the tank 112 and an air inlet 124 that enables air to enter the bottle 142 to replace the water that flows out. This air inlet 124 is connected to the swan-neck pipe 129. The cap 143 of the bottle 142 has an end-piece 120 that is adapted to come into contact with the upper part of the drawing finger 122 and includes a central pipe that is provided with lugs 121 for fixing it to the finger 122. A wall 123 inside the drawing finger 122 provides the separation between the air circuit 127 and the water circuit 126 that discharges into the tank 112.

FIG. 16 also shows an upper ring 134 of the receiving lid 103 and a lower face 133 of this ring 134, which is intended to rest on the tank 112. O-rings 132 provide a seal between the tank 112 and the receiving lid 103. A lug 131 has an indexing function during mounting on the tank and also retains the upper side of the axle 136 of the float.

FIG. 21 is an exploded view showing the components of the water cooler. There may be seen, in particular, a lid 144 (see also FIG. 20) that is placed on the receiving lid 103 to close the water cooler as a whole.

It is also seen that the annular float 104 is disposed around the frustoconical lower part of the receiving lid 103, above the air inlet of the swan-neck pipe 129 in order to be able to shut off the air inlet should the bottle 142 be punctured, while the air inlet of the pipe 129 is situated above the water inlet in the tank 112, i.e. above the base of the drawing finger 122. In practice, the latter is situated in the vicinity of the top of the finger 122.

For its part, the air inlet passage 174 is disposed above the top (upper end) of this drawing finger 122, in the upper part of the tank.

It can also be seen that a slightly flexible seal 155 is provided to make the seal when screwing in each tap.

FIG. 25 shows the water cooler of a variant of this latter embodiment of the invention.

Elements identical or similar to those of this embodiment are identified by the same reference numbers.

This variant differs from this embodiment in its use of silver ion diffusing means taking the form of a diffuser 200 having a perforated casing 201 in which are accommodated balls 202 with a coating adapted to diffuse silver ions into the water flowing in the diffuser. This diffuser 200 is removably mounted on the deflector 181, with a view to its replacement, by means of an opening in the latter.

Moreover, a secondary orifice 203 is provided in the pipe 129 to encourage the entry of air via its inlet 130.

Here it is provided in the pipe 129 in the vicinity of the junction thereof with the air inlet pipe 127 and at the end of this pipe 129 facing toward the base of the drawing finger 122.

In practice it is a calibrated orifice 203 for evacuating water that might penetrate into the pipe 127, and even the pipe 129, when placing a bottle 142 over the drawing finger 122 and, as a consequence of this, establishing as quickly as possible aspiration of air via the inlet 130 of the pipe 129 to enable optimum operation of the water cooler.

In this variant, there is further provided a chicane 204 at the upper end of the drawing finger (at the level of the air outlet 124), which rises in the air inlet pipe 127 beyond the level at which water enters the pipe 126, in order to oppose penetration of water into the pipe 127 discharging into the bottle 142 after the latter is put in place.

These latter two features may be used independently of each other.

It is nevertheless clear from the foregoing disclosure that the invention is not limited to the embodiments explicitly described in the above examples and that, to the contrary, it extends to any variant employing equivalent means. In particular, a chimney of non-cylindrical shape may be provided. The upper opening of the chimney may also be disposed in its lateral wall and a float may be provided that is pivotally mounted in order to shut off this upper opening of the chimney.

Moreover, the swan-neck pipe may be replaced by a pipe equipped with a float-based shut-off system, of the kind described above.

Replacing the mechanical float with an equivalent electrical or magnetic system may equally be envisaged, for example using water level sensing electrode.

Furthermore, the water cooler may be fed with water from a potable water network instead of the bottle, for example using a water cooler adapter of the type described in European patent EP 1 568 652, thus converting the bottle-fed water cooler into a mains-fed water cooler.

1. Dispensing part for bottle water coolers for dispensing at two different temperatures at least water drawn by gravity from an interchangeable bottle (58; 142), including a water drawing finger (32; 122) intended to be engaged in the neck of the bottle and that comprises a water outlet pipe (36; 126) and an air inlet pipe (37; 127) into the bottle to replace the water drawn off, means (82, 33; 103) for dispensing water drawn off via the drawing finger, communicating with the water outlet pipe at the base of the drawing finger, and means (38; 129) for supplying ambient air connected to the air inlet pipe, characterized in that the dispensing means and the air supply means (38; 129) are adapted to allow the formation of a column of water coming from the bottle (58; 142) in the dispensing means (82, 33; 103) and above the level of the base of the drawing finger (32; 122).

2. Dispensing part according to claim 1, characterized in that the air supply means include an air inlet situated approximately at the level of an inlet in the drawing finger for water coming from the bottle.

3. Dispensing part according to claim 2, characterized in that it includes means for shutting off an air supply passage into which discharges the air inlet of the supply means, the shut-off means being adapted to be actuated to close the passage by the column of water if the level thereof accidentally exceeds a predetermined level.

4. Dispensing part according to claim 2, characterized in that the air supply means include a swan-neck-shape pipe (15; 189) the free end of which forms the air inlet.

5. Dispensing part according to claim 1, characterized in that the water dispensing means include a chimney (33) in which stands the swan-neck-shape pipe and which discharges at its base into a compartment (82) for dispensing water at different temperatures.

6. Dispensing part according to claim 1, characterized in that it includes a water passage orifice intended to communicate with a cooling tank (6), a water at room temperature drawing outlet, a pipe for feeding chilled water from the cooling tank to a chilled water drawing outlet (42) that the dispensing part also includes.

7. Dispensing part according to claim 6, characterized in that it includes a water at room temperature outlet intended for a water-heater and a drawing outlet (40) for water heated by the water-heater.

8. Dispensing part according to claim 5, characterized in that it is made in two parts, namely an upper part including the chimney and a lower part taking the form of a deflector (13) for dispensing water at different temperatures, adapted to be attached to the upper part.

9. Dispensing part according to claim 1, characterized in that it takes the form of a lid (1) adapted to cover in sealed manner a cooling tank (6) of the water cooler that is open at the top.

10. Dispensing part according to claim 3, wherein the water dispensing means include a chimney (33) in which stands the swan-neck-shape pipe and which discharges at its base into a compartment (82) for dispensing water at different temperatures, and an air filter (19) is accommodated in the upper opening of the chimney and the shut-off means include a valve for shutting off the opening controlled by a float adapted to be actuated by the water column, mounted in the chimney under the air filter.

11. Dispensing part according to claim 1, characterized in that it has a flared overall shape, the air supply means including a swan-neck-shape pipe running laterally alongside the dispensing part and the free end of which forms the air inlet.

12. Dispensing part according to claim 1, characterized in that the ambient air supply means include a calibrated orifice (203) for evacuating water when placing the bottle.

13. Dispensing part according to claim 1, characterized in that the drawing finger includes a chicane (204) adapted to oppose entry of water into the air inlet pipe during placing of the bottle.

14. Water cooler for dispensing water at two different temperatures at least from water drawn by gravity from an interchangeable bottle intended to be placed upside-down on said water cooler or a drinking water network by means of an adapter, characterized in that it includes a dispensing part according to claim 1.

15. Water cooler according to claim 14, characterized in that it includes a cooling tank (112) in two parts, disposed under the dispensing part, the upper part of this tank forming with the dispensing part a compartment for dispensing water at different temperatures, the tank being equipped with outlets for water at different temperatures in this upper part.

16. Water cooler according to claim 15, wherein the air supply means include an air inlet situated approximately at the level of an inlet in the drawing finger for water coming from the bottle, and the dispensing part includes means for shutting off an air supply passage into which discharges the air inlet of the supply means, the shut-off means being adapted to be actuated to close the passage by the column of water if the level thereof accidentally exceeds a predetermined level, the air supply passage is formed in the upper part of the cooling tank and the shut-off means include a float (104) provided with a member for shutting off the passage pivotally mounted in the upper part of the cooling tank.

17. Water cooler according to claim 14, characterized in that it includes a removable second tank (5) that is nested in the cooling tank (6).

18. Water cooler according to claim 17, characterized in that the removable tank includes a channel (48) that is formed in the exterior face of its wall and that constitutes an air passage between the exterior of its wall and the interior of the wall of the cooling tank.

19. Water cooler according to claim 17, characterized in that the removable tank is produced in a plastic material that includes silver ions.

20. Water cooler according to claim 17, characterized in that it includes a silver ion diffuser (200) in the cooling tank or the removable tank.

21. Water cooler according to claim 16, characterized in that it includes an air filter disposed on the air supply passage.

22. Water cooler according to claim 14, characterized in that dispensing taps are fixed to the tank at the level of the tank water inlet.

23. Water cooler according to claim 22, characterized in that the dispensing taps are mounted by means of quick-fit connectors on outlet tubes that are attached to the tank.

24. Water cooler according to claim 23, characterized in that it includes at least one additional pipe that is connected to a water at room temperature outlet tube and/or to a chilled water outlet tube.

25. Water cooler according to claim 15, characterized in that it includes a deflector (181) that is disposed in the tank and divides the tank into two parts.

26. Water cooler according to claim 25, characterized in that the deflector includes a connector for a dip tube (112) to pass through intended to draw chilled water from the bottom of the tank.

27. Water cooler according to claim 14, characterized in that it includes a hot water tap that is adapted to be connected by a quick-fit connector to a double connector, preferably by coaxial pipes, which connector is intended to be connected to a water-heater by two pipes, one for water at room temperature, the other for hot water.
